(19) United States
(12) Patent Application Publication
(10) Pub. No.: US 2009/0146953 A1
(43) Pub. Date: Jun. 11, 2009

(54) Methods for processing data from accelerometer in anticipating real-time cursor control movements

(75) Inventors: Ruey-Der Lou, Hsinchu City (TW); Wen-hsiung Yu, Nantou City (TW)

Correspondence Address: Bo-In Lin, 13445 Mandoli Drive, Los Altos Hills, CA, 94022, US

(73) Assignee: IMU Solutions, Inc.

(21) Appl. No.: 11/981,330

(22) Filed: Oct. 30, 2007

Related U.S. Application Data
(60) Provisional application No. 60/855,718, filed on Oct. 30, 2006.

(51) Int. Cl. G09G 5/08

(52) U.S. Cl. 345/163

(57) ABSTRACT

A method for controlling a display cursor includes a step of receiving and processing signals from an accelerometer included in a cursor control device by applying a low-pass filter for filtering out signals received from an accelerometer having a frequency higher than a cutoff frequency and adjusting the cutoff frequency depending on a speed of a cursor movement controlled by a speed of angular position change of the display cursor control device.

This Formal application claims a Priority Date of Oct. 30, 2006 benefited from a Provisional Patent Applications 60/855,718 filed by an Applicant as one of the Inventors of this application. The disclosures made in Patent Application 60/855,718 are hereby incorporated by reference in this application.

### BACKGROUND OF THE INVENTION

1. Field of the Invention

This invention relates generally to a display-cursor control device such as a computer mouse for graphic user interface (GUI). More particularly, this invention relates to an improved cursor control device implementing new methods for processing data from accelerometer in anticipating real-time cursor control movements for providing different sensitivities during different types of cursor movements for reducing noises and stabling cursor control to enhance a multiple dimensional tilt angle control of a display cursor.

2. Description of the Prior Art

Majority of conventional display cursor-control devices, e.g., computer mouse, is implemented with either optical movement sensing or measurements of ball rolling movement. Such devices are usually limited to operate on a flat surface that requires a certain space for device movement. Furthermore, in order to move the device, operation of such devices may often cause health hazards that includes harm to nerves on the hands, the arms and even more extended parts of the body and may even cause more serious problems. In order to resolve such problems and limitations, a wide variety of different types of cursor control devices have been disclosed and proposed. However, each of these different types of devices still has limitations and difficulties as further described below.

In order to overcome the limitation of the cursor control devices most commonly used, e.g., the computer mouse, acoustic mouse or cursor control systems implemented with RF signals are implemented. Such devices however require special signal receiving devices installed in a computer either on the keyboard or around a monitor. Such systems are therefore more costly and complicate to implement and do not provide useful and practical solution to replace the conventional computer mouse as a cursor control device.

In different patented inventions, the computer mouse is implemented as a glove such that the cursor control system can be operated when the mouse is lift away from a flat surface and there are also no requirements to install signal-receiving devices on the computer. These types of cursor control devices can also be implemented as rings that a user can put on the fingers to control the cursor movements. However, since the operations of these kinds of cursor control devices require totally different movement and coordination between the movement of hands or fingers with the movements of the cursor, these types of cursor control devices have not been well received in the market.

There are also gyroscopic pointing devices that implement the cursor control system with gyro to move the cursors with mouse orientations. However, such mouse tends to be bulky and heavy. Furthermore, The device is more expensive to implement due to the more complicate gyro systems.

Image pointing control devices implemented with accelerometer are also disclosed in Patent WO0190877 where a cursor may be controlled by tilting the control device to different tilt angles. However, movements of cursor by tilting the mouse to different angles is often more difficult to implement with conventional configuration of computer mouse or other image pointing devices. Specifically, tilting operation of an image point device with flat bottom surface generally requires a supporting structure. Support structure is required because the cursor control is less stable when such device is operated in the mid air. It is therefore necessary to provide a support structure for the computer mouse such that cursor can be controlled with required stability. However, requirement of such supporting structure causes additional inconvenience and complications thus limiting practical application of such computer mouse or image pointing devices.

Therefore, a need still exists in the art of cursor control and pointing systems to provide new and easy to use system compatible with current control and point devices with low production costs such that the above discussed difficulties and limitations can be resolved.

### SUMMARY OF THE PRESENT INVENTION

One aspect of this invention is to provide a cursor control device that can flexibly operated without requiring the device to move along a flat surface. Specifically, the cursor can be controlled when the control device is lift up in the air and a cursor movement can be controlled by different kinds of movements. For example, in one embodiment, the control device can be tilted to the right-or-left to move the curse to the right or left respectively without having to move the control device horizontally. The control device can be tilted upwardly to move the cursor up or tilted downwardly to move the cursor down again without having to move the control device horizontally. The space saving is achieved since the tilt movements can be carried out without requiring putting the mouse on a flat surface and the cursor control is achieved with ease and convenience of cursor control with just wrist movements.

Another aspect of the present invention is to provide a curser control device or a point device pointing to a display image that has a curved bottom, e.g., an elliptical shape bottom surface. A user of the device can easily control the movement of a cursor or a display image by conveniently tilting the device in all directions with minimum hand and wrist movements. Such device requires very small surface area on a desk or on any surface for supporting the lowest contact area of the curve bottom surface. It is understood that such surface support is optional because the cursor can be moved by tilting the control device that can be performed under the condition that the control device is placed on a surface or lift up from a supporting surface without support.

Another aspect of the invention is to provide an improvement method for processing measurements detected by the acceleration sensor. The improved method that takes into practical considerations of the real movement of the pointing device that either is supported on a tabletop or is moved in the air. The new processing method applies different sensitivities for processing accelerometer measurements along different angular orientations to compensate for the differences in freedom of angular movements along different angular orientations of the wrist in tilting the device when the device is support on a surface. Specifically, the accelerometer has greater sensitivity in measuring tilt angle along a vertical direction in controlling the up and down of the cursor than the sensitivity of right or left tilt movements in controlling the cursor in moving to the right or left side respectively.

Another aspect of the invention is to provide an improvement method for processing measurements detected by the acceleration sensor wherein the method applies different acceleration measurement sensitivities at different movement speed. Specifically, when the cursor is moved at low speed or in the air, the acceleration measurement processing sensitivity is reduced such that the stability of cursor movement is improved to satisfy a user's demand that higher cursor stability is usually expected when the user is moving the cursor or a pointer at a lower speed.

Another aspect of the invention is to provide an improvement method for processing measurements detected by the acceleration sensor wherein the method applies a high measurement sensitivity and high-speed response for measuring a tilt angle relative to latest horizontal level based on a two-dimensional acceleration measurement. Also, the method of cursor control may be implemented by measurement of a three-dimensional movement of the control device such that the cursor control device or image point device can be operated with tilting control movements. Additionally, in order to add to the convenience of control, a mouse pad with curved surface is provided to generate a tilt movement as the user is moving the control device horizontally along different directions.

Briefly, this invention discloses a display cursor control device that includes a low-pass filter for filtering out signals received from an accelerometer having a frequency higher than a cutoff frequency wherein the cutoff frequency is dependent on a speed of a cursor movement controlled by a speed of angular position change of the display cursor control device.

In an exemplary embodiment, this invention further discloses a method for controlling a display cursor. The method includes a step of receiving and processing signals from an accelerometer included in a cursor control device by applying a low-pass filter for filtering out signals received from an accelerometer having a frequency higher than a cutoff frequency and adjusting the cutoff frequency depending on a speed of a cursor movement controlled by a speed of angular position change of the display cursor control device.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A to 1D are respectively a side perspective view, a top view a front view and a side cross sectional view of a display cursor control device, i.e., a mouse, of the present invention.

FIG. 2 is a perspective view of a mouse pad with a curved surface to allow a user to move a mouse horizontally for generating a tilting angle to move a cursor or a display image-pointing element.

FIG. 3 is a functional block diagram for showing the accelerometer implemented in a cursor control device or a graphic pointing device of this invention.

FIG. 4 is a functional diagram to show a personal computer (PC) as an exemplary data handling system that includes a display monitor with cursor controlled by a display control device as shown in FIGS. 1A to 3.

### DETAILED DESCRIPTION OF THE PREFERRED EMBODIMENT

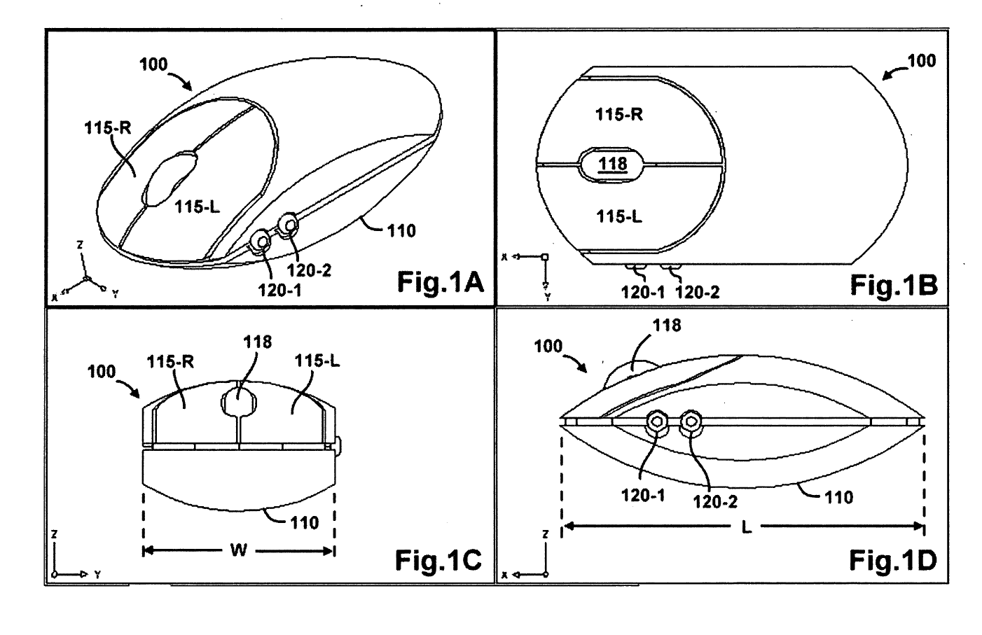

Please refer to FIGS. 1A to 1D for a perspective view, a top view a front view and a side perspective view of a display cursor control device, i.e., a mouse 100 of the present invention. The display-cursor control device 100 has a curved bottom surface 110 to enhance a movement for conveniently changing the tilt angle of the mouse. The display-cursor control device further includes an accelerometer for sensing a level variation of the mouse. The display cursor-control device such as a computer mouse with a curved bottom surface or a curved mouse pad, the mouse can be convenient tilted to different angles when the mouse or the mouse pad is place on a table. Soon as the mouse is moved to a new tilt angle, the accelerometer detects a level change. In response to the level change, a display cursor is moved on a user graphic interface (GUI) device, e.g., a computer monitor. More specifically, the display-cursor control device 100 as shown further has the following design functions.

As shown in FIGS. 1A to 1D, the width is illustrated along the Y-direction and the length is along the X-direction. In order to compensate the degree of movement differences of a human wrist, e.g., when the mouse is placed on a table, the wrist has greater freedom of movements in tilting to the right and left than upward or downward, the mouse 100 is design to have narrower width W and greater length L. The greater length, i.e., L>W, allows a more convenient tilt movement along the X-direction. Furthermore, the accelerometer is design to have greater measurement sensitivity when the mouse has a tilt angle along the X-direction than that along the Y-direction such that better control is achieved for a user in moving the cursor by tilting movements of the mouse. Therefore, a tilt angle θ relative to the X-axis generates a greater movement of the cursor along a vertical direction compared to a same tilt angle θ relative to the Y-axis.

In addition to the conventional right and left buttons 115-R, and 115-L and the wheel 118 as that regularly provided in the computer mouse, the mouse of this invention further includes two side buttons 120-1 and 120-2. The button 120-1 is programmed to function as a table-top/mid-air operation-mode button to alternate the operation of the mouse either to operate on the top surface of a table or to operate in the mid-air. The cursor control sensitivity is reduced when the mouse is operated in a mid-air mode. The button 120-1 can be replaced with a weight sensor placed on the bottom surface of the mouse. A weight sensing operation at the bottom surface of the mouse may be employed to alternate the mode of operation between a tabletop operation mode and a mid-air operation mode. The button 120-2 is programmed to function as an active/standby button. When the button 120-2 is pushed to an active mode, the tilt angle of the mouse is applied to control the cursor movement. When the button 120-2 is released (or toggled) to a standby mode, the cursor stays at one location and not moved with the movement of the mouse. The mouse can also provide a dual standby mood to turnoff the mouse when the mouse is idled without movement for a designated period to achieve power savings. It is another option to continuously press down both of the left and right buttons 115-R and 115-L to return the display cursor to the center of the display device.

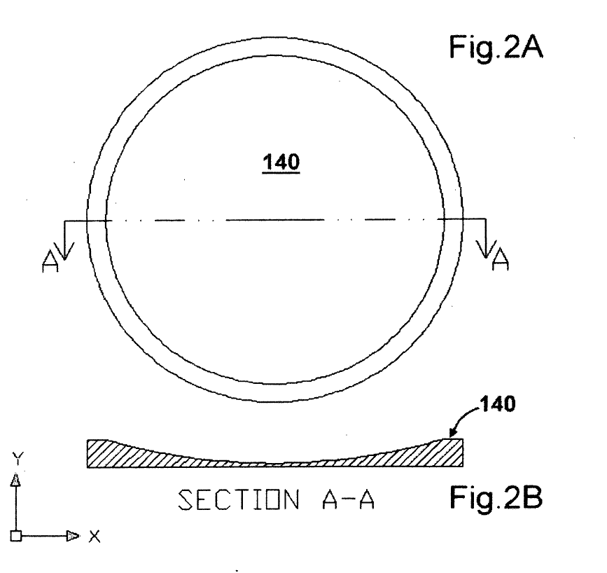

Instead of a mouse with a curved bottom surface discussed above, FIGS. 2A and 2B show an alternate embodiment with a mouse-pad 125 that has a curved surface is shown. As a user moves the mouse on the mouse pad 125, a tilt angle is generated and a cursor movement is created.

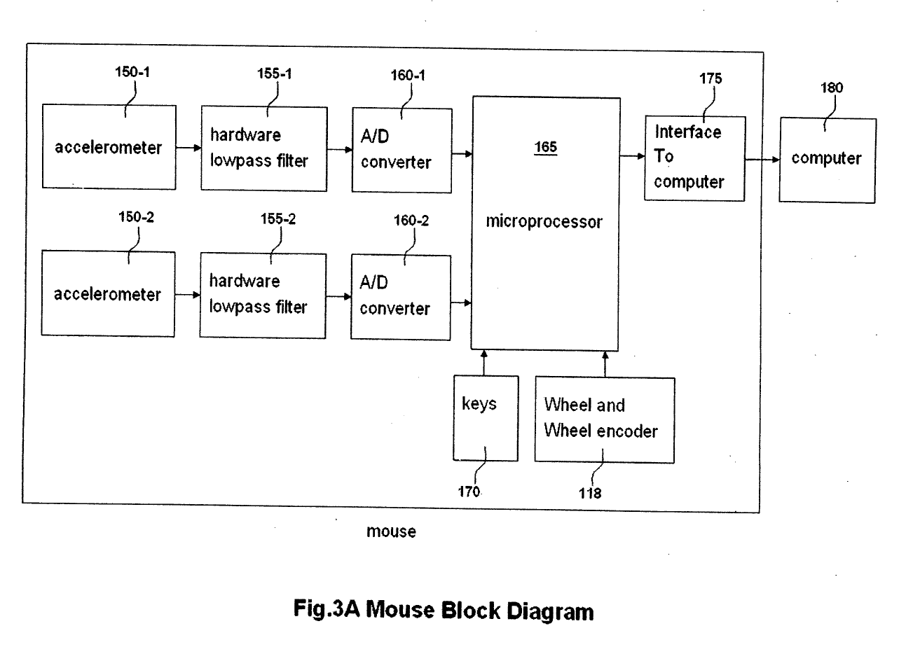

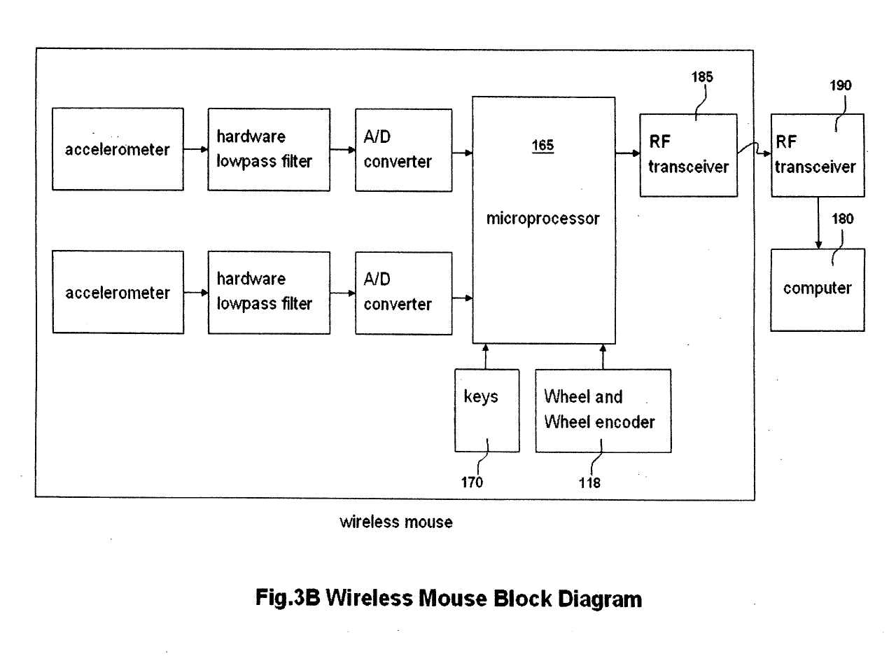

FIG. 3A shows a functional block diagram of a cursor movement control device such as a computer mouse that controls the movements of a cursor by sensing the angular tilt motions of a mouse implemented with two accelerometers. The cursor-movement control device includes a first accelerometer 150-1 and a second accelerometer 150-2 for detecting accelerations along two directions, e.g., acceleration along the X-direction and the Y-direction. The detected acceleration signals are transmitted to a first and a second low-pass filter 155-1 and 155-2 respectively to filter out some high frequency noises. The filtered signals are transmitted to a first and a second analog to digital converters (ADC) 160-1 and 160-2 to covert the analog signals to digital signals for inputting to a microprocessor 165. The microprocessor 165 also receives input signals from the keys 170 on the mouse, e.g., the signals generated from buttons 115-R, 115-L, 120-1 and 120-2. The microprocessor 165 further receives signals from the wheel 118 and wheel encoder for processing signals generated from the motion of the wheel 118. The microprocessor 165 carries signal processes as will be further described below to generate signals outputting to a computer 180 through a computer interface 175. The computer interface 175 typically generates a multiple digital data representing a cursor movement corresponding to the tilt angle changes of the mouse detected by the accelerometers 150-1 and 150-2.

FIG. 3B shows a functional block diagram of a wireless mouse that has a similar functional block configuration as the mouse shown in FIG. 3A. The only exception is that the wireless mouse shown in FIG. 3B further includes a RF transmitter 185 for transmitting signals of the movements of the cursor to the computer 180 that further includes a RF receiver 190 to receive the signals transmitted from the RF transmitter 185.

The microprocessor 165 carries out several functions in processing the digital data received from the analog-to-digital converter. In order to control the display cursor of the computer 180, an initialization process is carried out to initialize various parameters. After the initialization process, the microprocessor carries out a major task as a low pass filter to process the digital data according to anticipated conditions. There may be different anticipated conditions as listed below: 1) The mouse stay at a stationary position with no movement at all. 2) The mouse moves slowly. 3) The mouse moves at medium speed. 4) The mouse moves at high speed. The digital filter carried out digital signal process functions in anticipation of these conditions based on the detection of measurements from the accelerometers of the mouse movements such that stable and accurate cursor control can be achieved. The details of these data filtering processes are further described below.

The software program implemented to control the mouse movements can be generally categorized into five major parts. The first part is to carry out the function of setting the initial value of parameters. The second part of the program is implemented to calculate the present angular position. The third part of the program carries out the function of calculating the cursor position displacement according to the angular difference of the current angular position versus that of ten milli-seconds ago. The fourth part of the program deals with the process of slow motion of the mouse. And, the fifth part of the program manages the transfer of the cursor movement data to a computer.

Theoretically, once the measurement data of the accelerometer are available, a calculation using the measurement data can definitely obtain the current angular position of the mouse. However, the angular position of the mouse may not be accurately calculated practically due to the reasons that a user's hand holding the mouse may have vibrating or small but irregular movements. The measurement signals filtered by the low pass filter still have residual noise that can interfere and cause continuous variations of the value of the angular calculations. The values of the present angular position calculations cannot be directly applied to control the cursor movements. Because of the reason that these factors will cause the cursor to continuously move and making small but irregular and uncontrollable changes of position on a display screen corresponding the noise or the small movements of the hand. The uncontrollable small and sudden changes of cursor positions are not usually noticeable when the cursor is controlled to move at a high speed from one point on the display screen to another point with a large distance. This kind of uncontrollable “cursor floating” movements is often noticeable when the cursor is controlled to move at a slow speed. The uncontrollable cursor floating movements are even more annoying when the mouse is maintained at a fixed position without any movement. One method to overcome such problem is to modify some parameters of the filter in order to filter out more high frequency components of the measurement signal from accelerometer. There are several parameters can be modified to achieve this purpose. In order to simplify the description, the reduction of the cut-off frequency of the low pass filter will be used as an example in the following. Indeed, a reduced cut-off frequency can overcome such problem. However, a reduced cut-off frequency introduces another undesirable effect. A reduced cut-off frequency reduces the sensitivity of sensing the mouse movement and causes the cursor to become unresponsive to the mouse movements. A rule of control is implemented in this invention to resolve such difficulties. The rule is to provide greater stability and controllability when the cursor is controlled to move slowly. Conversely, when the cursor is controlled to move at a higher speed or over greater distances, the cursor stability and controllability become less important but the responsiveness of the cursor to the mouse movements become more important. For these reasons, the low pass filter of this invention is implemented with different values of cut-off frequencies according to the speed of cursor movements. Specifically, when the rate of change of angular position is small, the cut-off frequency is reduced. A lower cut-off frequency reduces the high frequency signals and increases the stability and controllability of the cursor. Conversely, when the rate of change of angular position is large for controlling the cursor to move at a high speed, the cut-off frequency is increased to increase the high frequency signals thus provides higher responsiveness of the cursor to the mouse movements. The higher level of signal noise due to the higher cut-off frequency may cause unstable small movements of the cursor, however when a cursor is controlled to move at a higher speed, such small “floating movements” of cursor become a minor concern because the user does not intend the control the cursor to point and maintain at a specific position but to move the cursor from one location to a different location on the display screen.

In an exemplary embodiment of this invention, a simple 100 Hz low pass filter is selected for the accelerometer as a hardware implementation to cutoff signals above a frequency of 100 Hz. In this invention, a special software low pass filter is also implemented where the cutoff frequency is dependent on the speed of mouse movements according to the accelerometer measurement of the rate of change of angular orientations. The software low pass filter executes a program every ten milliseconds (10 ms). By using the measurements of the accelerometer, a determination is first made of the changes of the angular positions of the mouse in this time interval of 10 ms for calculating the speed of mouse movement. A particular situation may occur when the speed of mouse movement is very slow the operation of the mouse may make several intermediate stops. A determination of the mouse movement speed cannot rely only on the angular difference between two time-points from the beginning to end of the 10 ms interval. Instead, an average speed has to be calculated by taking the angular differences between several 10-ms intervals and these consecutive angular position differences are taken into consideration for calculating an average mouse movement speed.

For convenience of implementation, the operations for processing the accelerometer measurements are divided into four categories. These four categories are 1) a stationary category when the mouse stays at one location without movement; 2) the mouse is moving at a slow speed, 3) the mouse is moving at an intermediate speed, and 4) the mouse is moving at a high speed. For each of these categories, different sets of low pass filter parameters are applied.

The calculation process executed by the software filter begins with a computation of the current angular position and compared with the previous angular position at ten milliseconds (10 ms) ago. The amount of angular movement is examined according to the process that if the amount of angular movement is smaller than a threshold value A, the difference is taken as a noise and no movement of the cursor is necessary. If the amount of the movement is greater than threshold A and lower than threshold B, then the angular position movement is multiplied by a value A to generate an amount of cursor movement. If the amount of the angular position difference is greater than threshold B and less than a threshold C, the amount that is greater than threshold B is multiplied by a greater value B to add to the portion multiplied by the value A to generate the cursor movement. The multiplication factor is gradually increased such that a gradually increasing weighting factor is applied when the mouse movement speed gradually increases such that a greater responsiveness of cursor to mouse movement is implemented. The speed-dependent low pass filter and the accumulation process for calculation of cursor movement achieve a similar purpose that the small and irregular hand movement of a mouse operator is applied with a lower sensitivity. The lower responsiveness of the cursor to the small mouse movement increases the cursor stability at slow movement when a user is typically attempting to point and control the cursor at a specific location. The slow cursor movements are provided with higher stability for greater controllability. Conversely, when the mouse is moving at a higher speed that is greater than certain threshold, a higher responsiveness of the cursor to the mouse movement is accomplished by the application of a greater weighting factor when calculating the cursor movement.

The above accumulative method has a limitation due to the fact if an operator is moving the mouse at a very low speed, the mouse may have already tilted a large angle, but since the angular change within every 10 ms is less than the smallest threshold value A, the cursor would still stay unmoved. A slow movement algorithm is implemented to manage these “micro-movement” conditions. In carrying out the micro-movement management program, a current angular position movement is calculated to determine if the angular movement along X-axis is less than the smallest threshold value. When the movement along the X-axis is less than the smallest threshold value, the movement of the cursor is designate as zero. In the meantime, the current angular position is compared with a referenced angular position along an X-axis direction to determine if the difference between the current angular position along the X-axis and that of the reference angular position is greater than a slow movement threshold, than the cursor is controlled to move one-pixel along the X-axis and the reference angular position is redefined to be the current angular position. The above algorithm is also applied to the movement along Y-axis. This method has an advantage because it enables a user to conveniently move the cursor one-pixel at a time by slowly tilting the mouse to precisely control the cursor movement with a slow motion.

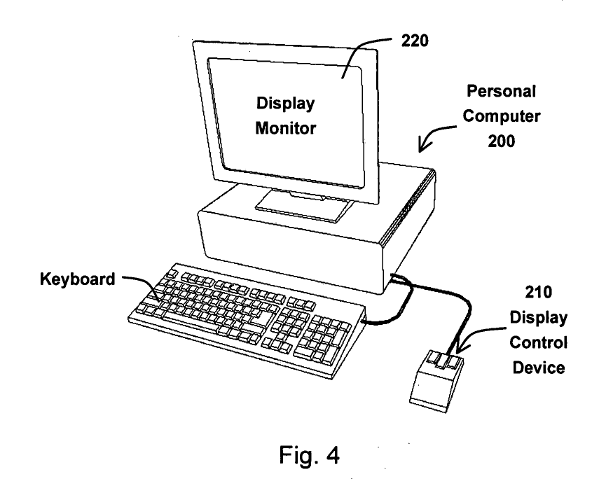

According to FIGS. 1 to 3 and the descriptions of the exemplary embodiments, this invention discloses a data handling system 200 as that shown in FIG. 4. The data handling system includes a display cursor control device 210 as shown in FIGS. 1 to 3 above for controlling a display cursor on a display monitor 220. The display cursor control device 210 further includes a low-pass filter for filtering out signals received from an accelerometer having a frequency higher than a cutoff frequency wherein the cutoff frequency is dependent on a speed of a cursor movement controlled by a speed of angular position change of the display cursor control device. In an exemplary embodiment, the data handling system includes a personal computer (PC) as shown in FIG. 4 and the PC 200 is connected to the display cursor control device 210 for receiving a signal therefrom to control the cursor movement. In another exemplary embodiment, the display cursor control device further includes a container housing having a curved bottom surface for conveniently tilting the display cursor control device to change a level of an accelerometer contained in the container housing. In another exemplary embodiment, the display cursor control device further includes a microprocessor for implementing the low-pass filter. In another exemplary embodiment, the display cursor control device further includes a wireless signal transmitter for transmitting display cursor control signals to the data handling system. In another exemplary embodiment, the low-pass filter of the display cursor control device adjusting the cutoff frequency according to a rate of change of angular position of the display cursor control device by reducing the cutoff frequency with a decreasing rate of change of angular position for increasing a stability and controllability of the display cursor at a lower moving speed. In another exemplary embodiment, the low-pass filter of the display cursor control device adjusting the cutoff frequency according to a rate of change of angular position of the display cursor control device by increasing the cutoff frequency with an increasing rate of change of angular position for increasing a responsiveness of the display cursor at a higher cursor moving speed. In another exemplary embodiment, the display cursor control device further includes a microprocessor for repetitively executing an angular position determination program over a predefined time interval for determining a change of the angular position in the predefined time interval for determining the speed of angular position change of the display cursor control device. In another exemplary embodiment, the microprocessor further repetitively executes the angular position determination program over a predefined time interval of approximately ten milliseconds (10 ms) for determining a change of the angular position of the display cursor control device. In another exemplary embodiment, the microprocessor further determining an average speed of angular position change over several of the time intervals if the speed of angular position change in a latest time interval is below a certain value in anticipating of the display cursor control device making several intermediate stops in a slow movement. In another exemplary embodiment, the microprocessor further generates a signal for controlling a display cursor to fix at an original position when the microprocessor determining the change of the angular position in the predefined time interval is below a noise threshold value. In another exemplary embodiment, the microprocessor further generates a signal for controlling a display cursor to move at speed by multiplying the speed of angular position change of the display cursor control device by a weighting factor corresponding to the speed of angular position change. In another exemplary embodiment, the microprocessor further calculates the weighting factor corresponding to the speed of angular position change by dividing the speed of angular position change into several speed ranges and applying a greater value of weighting factor to a higher speed range by multiplying to the speed of angular position change within the speed range whereby the display cursor is more responsive in a higher speed range and more stable at a lower speed range. In another exemplary embodiment, after the microprocessor determines that the change of the angular position in the predefined time interval is below the noise threshold value, the microprocessor further carries out a slow movement algorithm to determine a difference of between a current angular position and a reference angular position along a predefined direction and the microprocessor further generating a signal for controlling a display cursor to move one pixel along the predefined direction when the difference is greater than a cursor movement threshold even when a current change of the angular position in the predefined time interval is below the noise threshold. In another exemplary embodiment, the microprocessor carries out the slow movement algorithm along an X-axis. In another exemplary embodiment, the microprocessor carries out the slow movement algorithm along an Y-axis. In another exemplary embodiment, the display cursor control device further includes a container housing constituting a totally sealed enclosure housing whereby the display cursor control device is substantially a waterproof and dustproof container housing. In another exemplary embodiment, the display cursor control device is further operable for controlling a cursor movement of the data handling system on a supporting surface and in a mid-air space by tilting to different angular positions. In another exemplary embodiment, the display cursor control device further includes a container housing constituting an elliptic shaped container housing for conveniently titling to different angular positions. In another exemplary embodiment, the display cursor control device further includes a first and a second accelerometers for measuring tilt angles along a first and second mutually perpendicular axes wherein measurements of tilt angles along the first and second mutually perpendicular axes are applied two different cursor responsive parameters in controlling a cursor movements along the first and second mutually perpendicular axes

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A data handling system comprising a display cursor control device wherein said display cursor control device further comprising:
a low-pass filter for filtering out signals received from an accelerometer having a frequency higher than a cutoff frequency wherein said cutoff frequency is dependent on a speed of a cursor movement controlled by a speed of angular position change of said display cursor control device.

2. The data handling system of claim 1 further comprising:
a personal computer (PC) connected to said display cursor control device for receiving a signal therefrom to control said cursor movement.

3. The data handling system of claim 1 wherein:
said display cursor control device further comprising a container housing having a curved bottom surface for conveniently tilting said display cursor control device to change a level of an accelerometer contained in said container housing.

4. The data handling system of claim 1 wherein:
said display cursor control device further includes a microprocessor for implementing said low-pass filter.

5. The data handling system of claim 1 wherein:
said display cursor control device further includes a wireless signal transmitter for transmitting display cursor control signals to said data handling system.

6. The data handling system of claim 1 wherein:
said low-pass filter of said display cursor control device adjusting said cutoff frequency according to a rate of change of angular position of said display cursor control device by reducing said cutoff frequency with a decreasing rate of change of angular position for increasing a stability and controllability of said display cursor at a lower moving speed.

7. The data handling system of claim 1 wherein:
said low-pass filter of said display cursor control device adjusting said cutoff frequency according to a rate of change of angular position of said display cursor control device by increasing said cutoff frequency with an increasing rate of change of angular position for increasing a responsiveness of said display cursor at a higher cursor moving speed.

8. The data handling system of claim 1 wherein:
said display cursor control device further includes a microprocessor for repetitively executing an angular position determination program over a predefined time interval for determining a change of said angular position in said predefined time interval for determining said speed of angular position change of said display cursor control device.

9. The data handling system of claim 8 wherein:
said microprocessor further repetitively executing said angular position determination program over a predefined time interval of approximately ten milliseconds (10 ms) for determining a change of said angular position of said display cursor control device.

10. The data handling system of claim 8 wherein:
said microprocessor further determining an average speed of angular position change over several of said time intervals if said speed of angular position change in a latest time interval is below a certain value in anticipating of said display cursor control device making several intermediate stops in a slow movement.

11. The data handling system of claim 1 wherein:
said microprocessor further generating a signal for controlling a display cursor to fix at an original position when said microprocessor determining said change of said angular position in said predefined time interval is below a noise threshold value.

12. The data handling system of claim 1 wherein:
said microprocessor further generating a signal for controlling a display cursor to move at speed by multiplying said speed of angular position change of said display cursor control device by a weighting factor corresponding to said speed of angular position change.

13. The data handling system of claim 12 wherein:
said microprocessor further calculating said weighting factor corresponding to said speed of angular position change by dividing said speed of angular position change into several speed ranges and applying a greater value of weighting factor to a higher speed range by multiplying to said speed of angular position change within said speed range whereby said display cursor is more responsive in a higher speed range and more stable at a lower speed range.

14. The data handling system of claim 11 wherein:
after said microprocessor determining said change of said angular position in said predefined time interval is below said noise threshold value said microprocessor further carrying out a slow movement algorithm to determine a difference of between a current angular position and a reference angular position along a predefined direction and said microprocessor further generating a signal for controlling a display cursor to move one pixel along said predefined direction when said difference is greater than a cursor movement threshold even when a current change of said angular position in said predefined time interval is below said noise threshold.

15. The data handling system of claim 11 wherein:
said microprocessor carrying out said slow movement algorithm along an X-axis.

16. The data handling system of claim 11 wherein:
said microprocessor carrying out said slow movement algorithm along an Y-axis.

17. The data handling system of claim 1 wherein:
said display cursor control device further comprising a container housing constituting a totally sealed enclosure housing whereby said display cursor control device is substantially a waterproof and dustproof container housing.

18. The data handling system of claim 1 wherein:
said display cursor control device is further operable for controlling a cursor movement of said data handling system on a supporting surface and in a mid-air space by tilting to different angular positions.

19. The data handling system of claim 1 wherein:
said display cursor control device further comprising a container housing constituting an elliptic shaped container housing for conveniently titling to different angular positions.

20. The data handling system of claim 1 wherein:
said display cursor control device further comprising a first and a second accelerometers for measuring tilt angles along a first and second mutually perpendicular axes wherein measurements of tilt angles along said first and second mutually perpendicular axes are applied two different cursor responsive parameters in controlling a cursor movements along said first and second mutually perpendicular axes.

21. A display cursor control device comprising:
a low-pass filter for filtering out signals received from an accelerometer having a frequency higher than a cutoff frequency wherein said cutoff frequency is dependent on a speed of a cursor movement controlled by a speed of angular position change of said display cursor control device.

22. A method for controlling a display cursor comprising:
receiving and processing signals from an accelerometer included in a cursor control device by applying a low-pass filter for filtering out signals received from an accelerometer having a frequency higher than a cutoff frequency and adjusting said cutoff frequency depending on a speed of a cursor movement controlled by a speed of angular position change of said display cursor control device.
